(19) United States
(12) Patent Application Publication
(10) Pub. No.: US 2017/0214684 A1
(43) Pub. Date: Jul. 27, 2017

(54) A CONTEXTUAL SCANNING DEVICE WITH PRE-AUTHENTICATED IDENTITY

(71) Applicant: VCARE TECHNOLOGIES PVT. LTD., New Delhi (IN)

(72) Inventor: Vishal GUPTA, New Delhi (IN)

(21) Appl. No.: 15/327,657

(22) PCT Filed: Jul. 20, 2015
(86) PCT No.: PCT/IN2015/050067

§ 371 Date: Jan. 23, 2017

(30) Foreign Application Priority Data
Jul. 21, 2014 (IN) 2051/DEL/2014

(51) Int. Cl. H04L 29/06; H04L 29/08; H04W 12/06

(52) U.S. Cl. CPC H04L 63/0815; H04L 63/102; H04W 12/06; H04L 67/20; H04L 63/0428; H04L 67/18

(57) ABSTRACT

The present invention relates to a system and method for providing communication based on predefined authenticated configuration. The system includes a contextual scanning reader device providing a mechanism of automatic pre-authentication of user identity without requiring user to enter login ID and password. When an action is triggered on reader device upon scanning a machine readable code (such barcode, virtual symbol, NFC/RFID tag etc.), it recognizes digitally encoded data using a reader/scanner. The decoded information is identified and associated with plurality of third party servers for service related information. This decoded information is supplemented with user contextual information such as identity, location, preferences or any other related information to make it a complete or better context for a third party service pre-authentication. Once the user is pre-authenticated with this information it is transmitted to the third party server. The third party server verifies the information received and generates the associated input response on device via application interface.

### FIELD OF THE INVENTION

The present invention relates to a pre-authentication based communication system and method. More particularly, relates to a context scanning and triggering device for enabling users to perform one or more action. Further, reduces time steps of authentication process with third party server while enhancing the context information of the triggered actions using a common scanner.

### BACKGROUND OF THE INVENTION

During single sign-on (SSO), a user has to login once to gain access to different applications or merchant sites using a single user credential, even without requiring to login multiple times. For example, using a single google ID and password a user can login into flipkart account, Facebook account, LinkedIn account etc. This single user credentials can also be used for financial transaction processing. In SSO, when a user attempts access to an application, the application login server authenticates the user with the entered username & password. This user pre-verified user identity is passed to different applications and user is marked as being authenticated with encrypted login cookies. Now for subsequent user logins, the login cookie provides the Login Server with the user's identity, and indicates that authentication has already been performed. If there is no login cookie, the Login Server presents the user with a login challenge. The SSO does not differentiate between multiple applications and their corresponding login identity, since there is only one identity used for multiple applications login. For example a shopping site related user identity will be different form payment related user identity. Beside that SSO will try to Sign-in with same user identity with banking application and food ordering application without even recognizing the type of application used, and therefore user has to remember various identity related information for signing into different applications, which is a cumbersome process.

There are several applications available for computers and mobile phones. The user has to open many apps/websites separately for login, which is a tedious process. What is needed is to reduce the amount of time of processing by minimizing server overhead of user identity verification & authentication, steps taken to select/launch a particular application/website, and login to navigate to the appropriate options/pages.

Further, if a user is visiting any places such as shopping mall, airport, Library, office, home, public place restaurant and would like to make a request such as an order for food or invoice payment clearing for the order. Initially user needs to login into the application account and search for the menu for placing order. Apart from this user will be required to use debit/credit card and mobile/email account for card verification by SMS.

Currently on computers and mobiles all software's go through the process of device verification by either making a call or sending a code in SMS. Even the emails are verified for ownership by confirming a link, sent to the user. There is no single way of verifying the device ownership and emails etc.

Therefore there is a need for a method or system which eliminates prior art problem and provides a system and method enabling user to perform one or more triggered actions and automatic ownership of any triggered action without any verification and reducing the time/steps of verification/transaction processing.

### SUMMARY OF THE INVENTION

An object of the present invention is to provide a method for providing communication based on predefined authenticated configuration comprising acquiring information from a machine readable code by a reader device, providing an indication of one or more available third party services associated with the acquired information, selecting the third party service indication, processing the acquired information, wherein processing comprises supplementing the acquired information with one or more pre-authenticated user identifications and/or contextual information, associated with the third party service indication, transmitting the pre-authenticated information to the third party service and receiving response from the third party service.

A another object of the present invention is to provide a system for providing communication based on predefined authenticated configuration comprising a memory module comprising one or more instructions, a processing module connected with the memory module for executing the one or more instructions, a reader device in communication with the processing module, wherein the reader device operable to acquire information from a machine readable medium and processing the information according to the one or more instructions received from the processing module, to trigger one or more steps, comprising providing an indication of one or more available third party services associated with the acquired information, selecting the third party service indication, processing the acquired information, wherein processing comprises supplementing the acquired information with one or more pre-authenticated user identifications and/or contextual information, associated with the third party service indication, transmitting the processed information to the third party service and receiving response from the third party service.

A another object of the present invention is to provide a non-transitory computer-readable storage medium storing instructions that when executed by a processor of a communication device, configure the processor to trigger one or more steps comprising acquiring information from a machine readable code by scanning, providing an indication of one or more available third party services associated with the acquired information, selecting the third party service indication, processing the acquired information, wherein processing comprising supplementing the acquired information with one or more pre-verified user identifications and/or contextual information, associated with the third party service indication, transmitting the pre-authenticated information to the third party service in a secure communication and receiving response from the third party service.

A furthermore object of the present invention to provides a communication device capture/receives information from various sources via input information capturing unit. This source information comprise transaction data or payment link information, Login server details, service details etc. Once the information is received from the a input source a corresponding user pre-verified identification information is identified and supplemented with the user context information required by the third party servers. Once the details added to the source information user is pre-authenticated and this data is sent to the third party server. The third party server verifies it and a response for this verification is sent back to the user communication device.

A furthermore object of the present invention is to provide a universal contextual scanning device or system with pre-authenticated identity configuration for reducing time steps of authentication process with third party server.

### BRIEF DESCRIPTION OF THE DRAWINGS

Other objects, features, and advantages of the invention will be apparent from the following description when read with reference to the accompanying drawings. In the drawings, wherein like reference numerals denote corresponding parts throughout the several views:

FIG. 1 shows a simplified block diagram of a system (100) architecture in accordance with an embodiment of the present invention.

FIG. 2 shows a schematic diagram of a reader device (102) of FIG. 1 in accordance with an embodiment of the present invention;

FIG. 3 illustrates an application flow processes between mediation server (402) and reader device (401) according to an embodiment of the present invention.

FIG. 4 illustrates an example of automatic identity verification based on pre-authenticated user identity according to an embodiment of the present invention.

### DETAILED DESCRIPTION OF THE PREFERRED EMBODIMENTS

The present invention will now be described in detail with reference to the accompanying drawings.

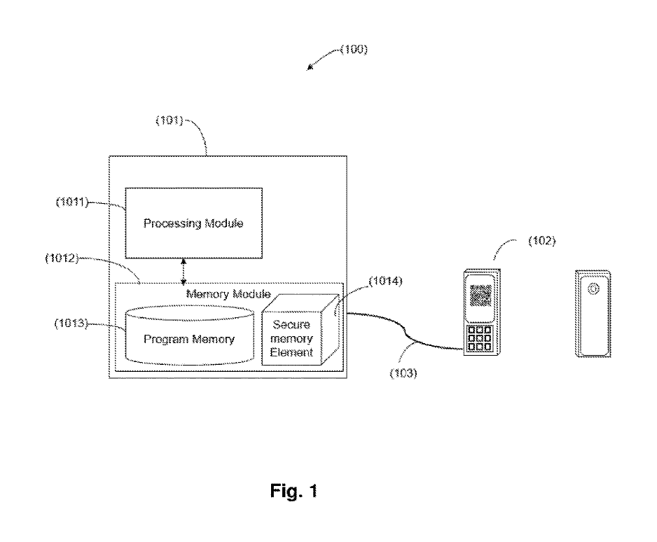

FIG. 1 shows a simplified block diagram of system (100) architecture in accordance with an embodiment of the present invention. The system (100) comprises mediation server (101) and a reader device (102) connected to the server (101). The Reader device (102) can be inside the server (101) or may be remotely located. The reader device (102) will be explained in detail later in the specification. The Server (101) comprises a processing unit (1011) and a memory module (1012). The memory module (1012) comprises a program memory (1013) for storing processor readable instruction to perform one or more task as specified therein and a secure memory element (1014) for storing pre-authenticated user identification/credentials and contextual information in encrypted form. The server (101) includes wired or wireless interface for communication with the reader device (102).

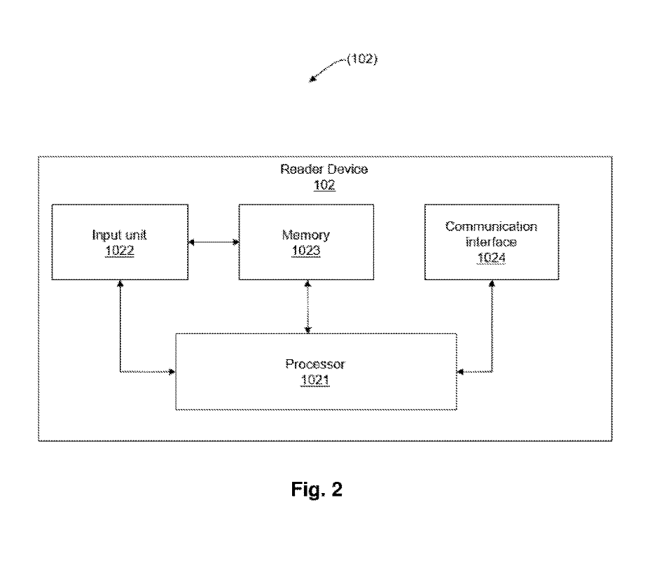

FIG. 2 shows a schematic diagram of a reader device (102) of FIG. 1 in accordance with an embodiment of the present invention. In embodiment, the reader device (102) comprises a memory (1023) storing instructions and a processor (1021) for executing set of instruction on acquired information data from machine readable medium and input unit (1022). The input unit (1022) may be part of reader device (102) or may be separate and in communication with reader device (102). In an embodiment of the present invention input unit (1022) may include for example, a reader such as a barcode reader, a QR code reader, microphone, a camera, a user input mechanism such as touchpad, keypad, or interactive display or other reading devices.

In another embodiment of present invention communication interface (1024) between the mediation server (101) and the reader device (102) is preferably realized as wireless communication, however, the connection may also be hard-wired. Further, reader device (102) configured to communicate with mediation server (302) using one more wireless mode of http communication such as GSM/UMTS/LTE mobile data network or Wi-Fi etc. The reader device (102) comprises one or more input source for acquiring information from machine readable medium such as camera, scanner, RFID scanner, NFC scanner etc. Further, reader device includes sensors and contextual information input source such as GPS/compass sensor for recognize user location, speaker, microphone etc. The reader device (102) accesses the mediation server over wireless or wired internet network. The wireless network may support GSM/UMTS/CDMA/LTE/Wi-Fi/Bluetooth communication for network access. The reader device (102) acquires/captures information from machine readable medium by scanning/reading.

In a preferred embodiment of present invention machine readable medium can be a virtual insignia. The virtual insignia comprises machine readable coded information. Further, a virtual Insignia can be a virtual symbol, optical codes such as one dimension, two dimensional or three dimensional code, QR Code, Barcode etc. and NFC tag for near field communication.

In an example, a reader device (102) via input unit (1022) captures information from machine readable medium such as QR Code and converts the information read for processing by the reader device. In another example the input unit such NFC/RFID scanner scans the wireless protocol signal from machine readable medium such as RFID/NFC tag transmitter and converts the information read into a form to be processed by reader device (102). The input unit (1022) such as camera, RFID has capacity or program instruction to perform scanning of machine readable medium.

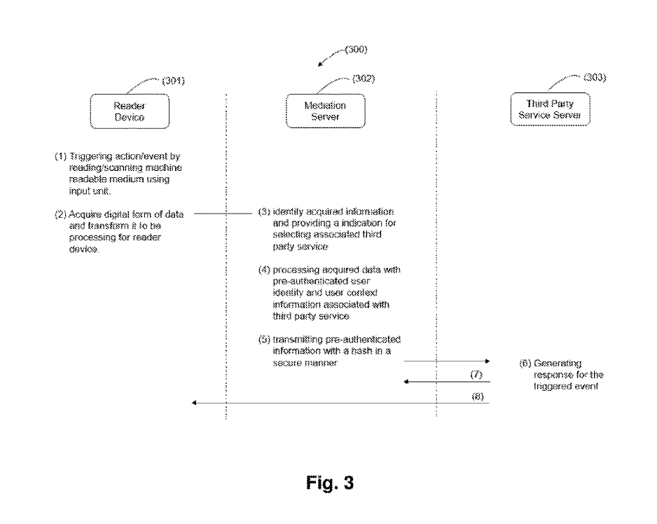

FIG. 3 illustrates system (303) service process flow among server, reader and third party server according to an embodiment of the present invention. The process starts (at step 1), when an input unit (1022) triggers an action or event upon reading/scanning a machine readable medium. The input unit (102) of the reader device (102) acquires (at step 2) digitally coded information from the medium and transforms this information for processing by reader device (102). The machine readable medium comprises a virtual symbol which can be a barcode or a NFC/RFID tag, text string etc., embedding digitally coded information therein. The transformed digital data is processed (at step 3) to identify associated action or event with it. The transformed information is sent to mediation server (302) for the processing and in response to that reader device (102) is provided with the few options for selecting third party service (303) associated with the action/event to be completed. In response to user selection with the service options provided, digital coded data is supplemented (at step 4) with contextual information such as pre-verified identity related information, device context, preferences or other information associated with the third party service (303). In another embodiment of the present invention digital coded information is automatically supplemented with the user contextual information, preferences or other information associated with third party service. The digital coded information is supplemented based on the user predefined setting related to service selection/preferences. In such case automatic login is performed by the system (300) without requiring any input from the user. The pre-authenticated user information is transmitted (at step 5) to the default/predefined/selected third party service provider (303). The communication between the server (302) and reader device (102) can be encrypted for security. The third party service generates a response corresponding to triggered action (at step 6) based on the supplemented information. The generated response may be an approval or in the form of a webpage, document, message or an alert etc.

In the step 4 and 5, user is authenticated with the pre-verified identity and this information is sent to server with a hash or checksum value. The received information (at step 6) is verified by the third party server or if information is incorrect, it returns to the step 3 and if information is correctly identified by the server a response corresponding to that triggered action is generated by the third party server (303) and returned to the reader device terminal (102).

According to another embodiment of present invention the Step 1 and 2 can be executed by integrated device.

Step 3 and 4 executed by reader device and server (202) together.

Step 5 can be executed by reader device and/or server (202).

Step 7 and 8 involve communication of response to reader device and/or server.

In an exemplary embodiment of the present invention input unit is a mobile camera unit or RF reader/NFC Reader. The input unit acquires the information from camera by scanning or taking picture or through RF source or by scanning radio signal. The acquired information is supplemented with user contextual information or preferences and user is automatically redirected to the third party service provider. The supplemented information may be pre-verified user identity which automatically logins user into third-party service provider system URL, read from barcode and user is directly logged into account.

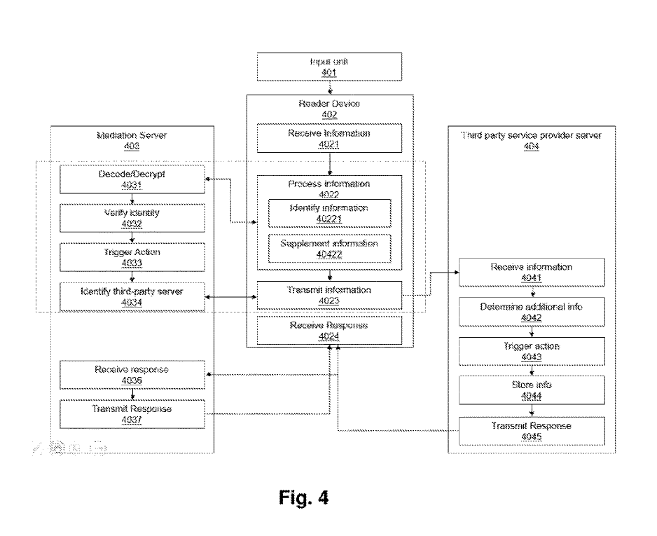

FIG. 4 illustrates an example of automatic identity verification based on pre-authenticated user identity according to an embodiment of the present invention. The input unit (401) converts the information read to a form that is used by the reader device (402), this form may be digital, analog, frequency, phase, or other form, or a combination thereof. After conversion of the information to a predefined format, input unit (401) provides this information to the reader device (402). The reader device processes (4022) the information and supplements (40422) it with additional optional information. The additional information includes a user's pre-verified identity, a preferred third party service provider (404) details, context, preferences, and other available additional information. The reader device (402) processes this information from input unit (401), with the help of mediation server (403). After processing this pre-authenticated information is transmitted (4023) to the third party service provider (404).

The mediation server (403) receives the transmission and, if applicable, decodes or decrypts (at 4031) the received information. The server (403) then verifies the identity of the user of reader device (402), triggers actions that may be identified based on the received information, such as determining context of the user, and identifies a service server of a third party service (404) provider. The mediation server (403) authenticates the user triggered action with the pre-verified identity/contextual information associated with the third party server (403). This pre-authenticated user's context and other information, server transmits (at 4023) to the identified server of the third party service provider (i.e., in third party system 404).

The Third party system (404) receives (at 4041) the transmission (at 4023) from mediation server (403). The third party service server (404) may also receive this transmission from reader device (402). Third party server (404) determines (at 4042) additional information to be used, such as based on the context of the user, trigger (at 4043) actions to be taken and stores (at 4044) a portion of, or all of, the received information and the determined information. Third party server (404) then transmits (at 4045) a response (at 4024, 4036) to reader device (402) and mediation server (403).

The Mediation server (403) receives (at 4036) the transmission from third party server (404), and transmits (at 4037) a response to reader device (402).

The reader device (402) receives (at 4024) the transmission (at 4037) from third party server (404) and the transmission (at 4037) from mediation server (403). In this manner, by way of initiating a reading at input unit (401), a response to a request may be received at reader device (402) without additional user input (i.e., no user input other than initiating a reading/scanning). In one or more embodiments, however, additional user input requests may be implemented.

In an embodiment of present invention, a reader device (402) can provide its location and/or a verified identity to a third party (404) along with other context with a single click or action that captures information from the machine readable medium and converts the coded information/context information into a form suitable for transmission.

The communication may be made secure or encrypted at any stage using any of the state of the art technologies. The verified identity may be exchanged based on certain conditions or user input.

In one or more embodiments, the reader device (402) by reading a virtual symbol, automatically opens a website and, secure login is automatically performed. Other options can be provided based on a purpose of the virtual symbol, and may be related to a location or time, or to user preferences. This fast and simple-to-use technique provides for reader device verification without user input, other than perhaps initiating the reading of the virtual symbol (e.g., without user input such as first making a call, sending a code via SMS or text, or verifying ownership by confirming a link sent in an email). Another benefit of the quick and simple-to-use technique described is that it replaces the opening of many applications and websites separately, followed by logins for each.

According to another embodiment of present invention upon a trigger, the virtual symbol is read at or by the reader device. Reading the virtual symbol may be performed by a reader, for example, by a scanner, a QR reader, a data goggles, an application with user input, a microphone, a camera, or other sensing device. The machine coded information from the virtual symbol is converted to digital data and may be supplemented with context information such as identity, location, preferences or other related information by an App, and is provided to a third party service provider (e.g., by way of API, http, or other technique). Alternatively, the virtual symbol information and supplemented information may be divided into multiple portions (e.g. divided by context, or divided into multiple transmissions), and provided to one third party service provider, or the portions provided to multiple third party service providers. Logs may be kept of virtual symbol reads, or of information provided to third parties. The third party service provider generates an output or action that is appropriate based on the virtual symbol and supplemented information. The communication between the reader device and the third party service provider may be tokenized for improved security. A server may be used to mediate the communication (see, e.g., the description of FIG. 4). The reader device may receive input back from a third party as part of workflow, or to trigger other actions or responses on the reader device.

A virtual symbol reader may have multiple identities, one of which may be used to trigger the reading of virtual symbol. An identity may have more than one identifier, such as one or more mobile numbers, and/or one or more email addresses. The reader may have one or more passwords, and may have partial identifiers such as date of birth or last four digits of a Social Security number or bank account. The reader stores this information in a secure memory or request from the mediation server. Some or all of these identifiers may be passed on to a third party service provider based on context or request.

A list of context information to include in the information provided to a third party service provider may be determined by a trigger used. Such a list may include weather data, temperature, location, a Wi-Fi list, network details, credit card details, language preferences, eating habits, and allergies, for example. The trigger may require the list to be retrieved from the third party service provider or from another third party.

A list of approvals and trusted third party service providers may be kept with the reader to manage privacy concerns. Some embodiments are particularly useful with respect to symbols (e.g., a QR code, a bar code or other symbol). For example, presently the reading of a QR code triggers a URL to be opened, and further action is then expected of the user. As described in accordance with this disclosure, however, a QR code may instead directly log a customer into a customer account, and open a page or a transaction relevant to the context of the QR code. In one or more embodiments, a trigger provides a pre-authentication to the third party service provider (see, e.g., the description of FIG. 4). In certain circumstances, a trigger may also trigger an authorization.

By way of another example, a data goggles may be the initiator of a trigger on object recognition, or by user initiation.

Identity of an initiator (or associated user) may or may not be fully disclosed to the third party service provider, and may instead be fully or partially concealed by way of hashing, encryption or compression.

In one or more embodiments, momentary contexts may be created temporarily by a reader or multiple linked readers. A momentary context may contain expiry information, such that the momentary context is removed automatically at the expiration of a time or at a change in location, for example. Such contexts may be added to subsequent triggers momentarily also. A trigger may be as simple as a user touch on a tablet, or as complex as a QR code embedded with pre-standardized instructions for trigger processing. The trigger could further route the trigger information to a preferred service provider included in predefined preferences.

As described above, a virtual symbol may be converted to a form suitable for transmission, which may include a hashing of the virtual symbol. For example, the virtual symbol may be a mobile number, and may be transmitted as a hash of a mobile number along with the country code. A reader device may use public key encryption to send data to a mediation server, which may then use another public key encryption to send trigger information and context data to a third party service provider. The third party service provider may then return output data to the reader device directly or indirectly (see, e.g., the description of FIG. 4).

In one or more embodiments, the information in a virtual symbol is standardized, and recognition is embedded in the trigger to channelize the information to a user-preferred third party service provider. For example, a blood report may be incorporated into a QR code that gets routed to the user-preferred personal health data repository.

In one or more embodiments, a method is published on a network (e.g., the Internet) to create standardized triggers compatible with localized readers. In one or more embodiments, triggers may be used to discover new choices or reduce the amount of choices available to a user. For example, there are presently over a million applications for mobile devices and over a billion websites. It is increasingly daunting to know how to search for an appropriate website. The concepts of this disclosure make a search more reliable, contextually relevant, faster, secure, and saves time by automating authentication.

In one or more embodiments, a common platform is provided, where the following scenario examples may be handled by configuring triggers on the platform:

User is in a restaurant→custom menu, queue management and alerts, ordering, invoicing

User is at the airport→auto check-in, flight status

User is in a shop I mall→best deals available

User is in library→scan location of titles

User is at school notice board, time table, and homework

User is in an office→visitor management, access directories, and track deadlines

User is at home→single location of critical contacts, home automation

User is at a public place→access to information, timings, parking or entry tickets, history, scores, etc.

There may also be automated pre-approved triggers in the platform that may be used, for example, to switch on lights or for other automation. Context elements of a trigger may include but are not limited to: identity related information such as address, phone number, instant messaging (IM) identifier, and tweet handle; location; transmitter Id; Mac ID survey result; date; time; weather; preferences such as language, food, allergies, and theme; preferred software such as Quick books, Tally, Salesforce, or a health data bank; pre-selection such as table number, or bottle; direction of movement; historical data; group information; status; mobile device details; user input; photo; bar code; QR code; and payment information.

A trigger may further control the variations of context that are provided to a third party service provider. A trigger may include cascading triggers to accomplish multiple tasks.

In one or more embodiments, a common mobile platform is provided that captures and stores context elements, verified identities, and localized triggers for accessing multiple third party information services using multiple configurable triggers on a mobile reader device. The information accessed from a third party can include, but is not limited to, text, audio, video, scent, objects, or data streams or other binary data. The information accessed from a third party may further trigger context specific advertisements to be retrieved from the network (e.g., Internet) to show to a user.

In another embodiment of the invention context scanner or trigger can be referred as Context Engine or a Universal Scanner.

In another embodiment of the invention communication between the servers may be encrypted communication.

All references of reader device may be assumed as computing device interchangeably and includes scanner and other mobile computing devices, communication device etc. Further, terms like “device” and “system” are used interchangeably and synonymously throughout this document.

Obviously, numerous modifications and variations of the present disclosure are possible in light of the above teachings. It is therefore to be understood that within the scope of the appended claims, the disclosure may be practiced otherwise than as specifically described herein.

In the claims, the word “comprising” does not exclude other elements or steps, and the indefinite article “a” or “an” does not exclude a plurality. A single element or other unit may fulfill the functions of several items recited in the claims. The mere fact that certain measures are recited in mutually different dependent claims does not indicate that a combination of these measures cannot be used to advantage.

In so far as embodiments of the disclosure have been described as being implemented, at least in part, by software-controlled data processing apparatus, it will be appreciated that a non-transitory machine-readable medium carrying such software, such as an optical disk, a magnetic disk, semiconductor memory or the like, is also considered to represent an embodiment of the present disclosure. Further, such a software may also be distributed in other forms, such as via the Internet or other wired or wireless telecommunication systems.

A circuit is a structural assemblage of electronic components including conventional circuit elements, integrated circuits including application specific integrated circuits, standard integrated circuits, application specific standard products, and field programmable gate arrays. Further a circuit includes central processing units, graphics processing units, and microprocessors which are programmed or configured according to software code. A circuit does not include pure software, although a circuit includes the above-described hardware executing software.

I claim:

1. A method for providing communication based on predefined authenticated configuration comprising:
acquiring information from a machine readable code by a reader device;
providing an indication of one or more available third party services associated with the acquired information;
selecting the third party service indication;
processing the acquired information, wherein processing comprises supplementing the acquired information with one or more pre-authenticated user identifications and/or contextual information, associated with the third party service indication;
transmitting the pre-authenticated information to the third party service; and
receiving response from the third party service.

2. The method as claimed in claim 1 wherein processing the acquired information further comprises performing at least one of a pre-authentication of the identity and contextual information with the third party service indication at the reader device.

3. The method as claimed in claim 1, wherein the reading device comprises an input unit for acquiring information from the machine readable medium.

4. The method as claimed in claim 3, wherein the input unit comprising at least one of an optical code scanner, data goggle, sound scanner, or a wireless scanner.

5. The method as claimed in claim 4, wherein the optical code scanner comprises a digital camera, image scanner, 2D or 3D barcode scanner.

6. The method as claimed in claim 4, wherein the sound scanner comprises a microphone.

7. The method as claimed in claim 4, wherein the wireless scanner comprises a NFC scanner or a RF scanner.

8. The method as claimed in claim 1, wherein the machine readable medium comprises one or more coded instructions.

9. The method as claimed in claim 8, wherein the machine readable medium comprises an optical barcode, text or data string, audio signal, binary data or a NFC tag.

10. The method as claimed in claims 1, 8 and 9, further comprising:
identifying Wi-Fi networks available to the user device; and
providing a list of the available Wi-Fi networks to be displayed at the user device; wherein the text/data string is the name of an available Wi-Fi network.

11. The method as claimed in claim 1, wherein transmission between the reader device and third party service is an encrypted communication.

12. The method as claimed in claim 1, wherein the contextual information comprises at least one of a user information, location information, Network information, payment details, and preferences.

13. The method as claimed in claim 12, wherein the user information comprises at least one a user ID, mobile number, personal preferences, status, group information, direction of movement, inputs, location information, network information, payment details and user preferences,
where the location information comprises geo location, weather information, date & time,
where the network information comprises transmitter ID, MAC ID, device identifier,
where the payment details comprises debit/credit card details, account credentials,
where the user preferences comprises language, food, and allergies theme.

14. The method as claimed in claim 1, wherein the step of receiving response comprises a webpage, document, message or an alert.

15. A system for providing communication based on predefined authenticated configuration comprising:
a memory module comprising one or more instructions;
a processing module connected with the memory module for executing the one or more instructions;
a reader device in communication with the processing module, wherein the reader device operable to acquire information from a machine readable medium and processing the information according to the one or more instructions received from the processing module, to trigger one or more steps, comprising:
providing an indication of one or more available third party services associated with the acquired information;
selecting the third party service indication;
processing the acquired information, wherein processing comprises supplementing the acquired information with one or more pre-authenticated user identifications and/or contextual information, associated with the third party service indication;
transmitting the processed information to the third party service; and
receiving response from the third party service.

16. The system as claimed in claim 15, wherein processing the acquired information further comprises performing at least one of a pre-authentication of the identity and contextual information with the third party service indication at the reader device.

17. The system as claimed in claim 15, wherein the reading device comprises an input unit for acquiring information from the machine readable medium.

18. The system as claimed in claim 17, wherein the input unit comprising at least one of an optical code scanner, data goggle, sound scanner, or a wireless scanner.

19. The system as claimed in claim 18, wherein the optical code scanner comprises a digital camera, image scanner, 2D or 3D barcode scanner.

20. The system as claimed in claim 18, wherein the sound scanner comprises a microphone.

21. The system as claimed in claim 18, wherein the wireless scanner comprises a NFC scanner or a RF scanner.

22. The system as claimed in claim 15, wherein the machine readable medium comprises one or more coded instructions.

23. The system as claimed in claim 22, wherein machine readable medium comprises an optical barcode, text/data string, audio signal, binary data or a NFC tag.

24. The system as claimed in claim 15, wherein transmission between the reader device and third party service is an encrypted communication.

25. The system as claimed in claim 15, wherein contextual information comprises at least one of a user information, location information, Network information, payment details, and preferences.

26. The system as claimed in claim 15, wherein the receiving response comprises a webpage, document, message or an alert.

27. A non-transitory computer-readable storage medium storing instructions that when executed by a processor of a communication device, configure the processor to trigger one or more steps comprising:
acquiring information from a machine readable code by scanning;
providing an indication of one or more available third party services associated with the acquired information;
selecting the third party service indication;
processing the acquired information, wherein processing comprising supplementing the acquired information with one or more pre-verified user identifications and/or contextual information, associated with the third party service indication;
transmitting the pre-authenticated information to the third party service in a secure communication; and
receiving response from the third party service.

28. The non-transitory computer-readable storage medium as claimed in claim 27 wherein processing the acquired information further comprises performing at least one of a pre-authentication of the identity and contextual information with the third party service indication at the reader device.
